(19) United States
(12) Patent Application Publication
(10) Pub. No.: US 2013/0196893 A1
(43) Pub. Date: Aug. 1, 2013

(54) Hard Surface Cleaners Comprising Low VOC, Low Odor Alkanolamines

(71) Applicants: Molly I. Busby, Midland, MI (US); Ian A. Tomlinson, Midland, MI (US)

(72) Inventors: Molly I. Busby, Midland, MI (US); Ian A. Tomlinson, Midland, MI (US)

(21) Appl. No.: 13/878,907

(22) PCT Filed: Nov. 11, 2011
(86) PCT No.: PCT/US11/60399

§ 371 Date: Apr. 11, 2013

Related U.S. Application Data
(60) Provisional application No. 61/414,058, filed on Nov. 16, 2010.

(51) Int. Cl. C11D 3/30

(52) U.S. Cl. CPC C11D 3/30
USPC 510/499

(57) ABSTRACT

Hard surface cleaning compositions comprise: A. Surfactant, e.g., a nonionic ethoxylated alcohol; B. Solvent, e.g., propyleneglycol n-butyl ether; C. Low VOC, low odor, alkanolamine selected from the group consisting of tris(hydroxymethyl)amino methane; 2-amino-2-methyl-1,3-propanediol; 2-amino-2-ethyl-1,3-propanediol; 2-amino-2-methyl-1-propanol; N,N-dimethylamino-2-methyl-1-propanol; and 3-amino-4-octanol; D. Water, and E. Optionally, one or more of an alkaline agent, builder, fragrance, preservative, biocide, colorant, dye and rheology modifier.

### BACKGROUND OF THE INVENTION

1. Field of the Invention

This invention relates to hard surface cleaners. In one aspect the invention relates to hard surface cleaners comprising alkanolamines while in another aspect, the invention relates to hard surface cleaners comprising alkanolamines that are low or zero volatile organic compounds (VOC) and that have little, if any, odor.

2. Description of the Related Art

Ethanolamines, including monoethanolamine (MEA), diethanolamine (DEA), and triethanolamine (TEA), are labeled as possible respiratory sensitizers based on anecdotal information from cases reporting the use of complex mixtures and non-standard animal models (see, for example, Kamijo and Nagai., “Acute Respiratory Distress Syndrome Following Asthma-Like Symptoms from Massive Ingestion of a Monoethanolamine-Containing Detergent”, Vet Human Toxicol, 46 (2) April 2004). MEA has been widely used as a key ingredient in hard surface cleaners, but a recently proposed standard would require all purpose cleaners (APC) to reduce their VOC content from the current 4% to 0.5% by weight by 2012. MEA is considered a VOC, and it also has a strong characteristic odor. Many manufacturers of hard surface cleaners are requesting alternative amines with little, if any, VOC content and little, if any, odor to replace MEA. Previous attempts that replaced MEA with mono-isopropanolamine showed promise in performance and a better toxicity profile, but mono-isopropanolamine is still a VOC, and its odor is even stronger than MEA.

Low volatility alkanolamines with bulky organic groups are not expected to provide cleaning efficiencies and filming and streaking performance comparable to monoethanolamine which has been used extensively in cleaning compositions. They were tested, however, because they are typically used for neutralization, have little, if any, VOC and in a number of cases little, if any, amine odor. Surprisingly, certain alkanolamines have been found to provide good cleaning, and some have filming and streaking performance comparable to monoethanolamine despite being low or zero VOC and having little, if any, odor under ambient conditions.

### SUMMARY OF THE INVENTION

In one embodiment the invention is a hard surface cleaning composition comprising an alkanolamine selected from the group consisting of tris(hydroxymethyl)amino methane; 2-amino-2-methyl-1,3-propanediol; 2-amino-2-ethyl-1,3-propanediol; 2-amino-2-methyl-1-propanol; N,N-dimethylamino-2-methyl-1-propanol; and 3 -amino-4-octanol.

In one embodiment the invention is a cleaning composition comprising:
A. Surfactant;
B. Solvent;
C. Alkanolamine selected from the group consisting of tris(hydroxymethyl)amino methane; 2-amino-2-methyl-1,3-propanediol; 2-amino-2-ethyl-1,3-propanediol; 2-amino-2-methyl-1-propanol; N,N-dimethylamino-2-methyl-1-propanol; and 3-amino-4-octanol; and
D. Water.
   Optionally, the cleaning composition can comprise one or more of an alkaline agent, dye, colorant, fragance and preservative. In one embodiment the cleaning compositions of this invention are also substantially, if not entirely, free of both alkyl polyglucosides and polyaluminum compounds. In one embodiment the cleaning composition is full strength and ready-to-use while in another embodiment, the cleaning composition is a concentrate requiring dilution prior to use.

In one embodiment the invention is a cleaning composition comprising in weight percent (wt %) based on the weight of the composition:
A. 0.01 to 20 wt % surfactant;
B. 0.1 to 25 wt % solvent;
C. 0.1 to 5 wt % alkanolamine selected from the group consisting of tris(hydroxymethyl)amino methane; 2-amino-2-methyl-1,3-propanediol; 2-amino-2-ethyl-1,3-propanediol; 2-amino-2-methyl-1-propanol; N,N-dimethylamino-2-methyl-1-propanol; and 3-amino-4-octanol; and
D. Water, quantum sufficit (q.s.).
   Water is typically the dominant component of the composition and in ready-to-use formulations, typically is present in excess of 95 wt % based on the weight of the composition. In concentrate formulations water is present in smaller amounts, e.g., less than 50 wt % based on the weight of the concentrate. If present at all, the optional components of the composition are present amounts typical for cleaning formulations, e.g., 0.01 to 1 wt % based on the weight of the composition.

### BRIEF DESCRIPTION OF THE DRAWINGS

FIG. 1 is an illustration of the procedure used to fold a 9 inch square of cheesecloth into an approximately 4.5×2.25 inch rectangle.

FIG. 2 is an illustration of the droplet pattern used to test a hard surface cleaner on a 4½ inch mirror tile for filming, streaking and cleaning.

FIGS. 3A-3C are a series of charts comparing across a range of temperatures the phase stability of cleaning formulations comprising tris(hydroxymethyl)amino methane or 3-amino-4-octanol against a cleaning composition comprising MEA.

FIG. 4 is a plot of the results of 123 filming and streaking tests. Filming results are shown on a 1 to 10 scale across the top of the figure. Streaking results are shown on a 1 to 10 scale on the right side of the figure.

### DETAILED DESCRIPTION OF THE PREFERRED EMBODIMENT

### Definitions

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the relative amounts of ingredients in a particular composition.

“Low or zero volatile organic compound (VOC)” and like terms mean a compound that has a vapor pressure less than or equal to 0.1 millimeters (mm) of mercury (Hg) at 20° C. The vapor pressure of a VOC is typically measured according to ASTM E-1719-97.

“Surfactant” and like terms mean a substance or compound that reduces surface tension when dissolved in water or water solutions, or that reduces interfacial tension between two liquids, or between a liquid and a solid. Surfactants include anionic, cationic, nonionic, zwitterionic and/or amphoteric agents.

“Substantially free of both alkyl polyglucosides and polyaluminum compounds” and like terms mean that the cleaning composition comprises less than 0.1, preferably less than 0.05 and even more preferably less than 0.01, wt % of either component alone or in combination with one another.

“Concentrate” and like terms mean a cleaning composition that requires dilution with water and/or other solvent to bring it into a ready-to-use state. Concentrates typically require a dilution factor of 1 to 10 or 1 to 20, i.e., 1 to 10 or 1 to 20 parts water and/or solvent by weight or volume is added to the concentrate to bring the concentrate to a ready-to-use state.

### Alkanolamines

The alkanolamines used in the practice of this invention are monoamines, i.e., each contains one nitrogen atom. The alkanolamines used in the practice of this invention also contain at least one oxygen atom separated by an ethylene or substituted ethylene bridge. This structure is the same as the basic structure of ethanolamines and similar to the structure of chelants such as ethylenediamines. This structure allows the alkanolamines to chelate metals. Unlike ethanolamines, and ethylenediamines, each of the alkanolamines of this invention also has a fairly bulky organic structure. This combination of a chelant structure and hydrophobic groups allows the alkanolamines to chelate metals in soils and emulsify them in aqueous systems, making them efficient cleaners. They are particularly suited for the removal of inorganic particulates such as magnesium silicates and aluminum silicates.

The alkanolamines used in the practice of this invention are selected from the group consisting of tris(hydroxymethyl)amino methane (CAS: 77-86-1); 2-amino-2-methyl-1,3-propanediol (CAS: 115-69-5); 2-amino-2-ethyl-1,3-propanediol (CAS: 115-70-8); N,N-dimethylamino-2-methyl-1-propanol (CAS: 7005-47-2); and 3-amino-4-octanol (CAS: 1001354-72-8). The preferred alkanolamines are tris(hydroxymethyl)amino-methane; 2-amino-2-ethyl-1,3-propanediamine; and 3-amino-4-octanol, and the more preferred alkanolamines are tris(hydroxymethyl)amino-methane and 3-amino-4-octanol. These alkanolamines can be used alone or in any one of a number of combinations with one another. One or more of the alkanolamines used in the practice of this invention are available from, among others, The Dow Chemical Company, ANGUS Chemical Company (a wholly owned subsidiary of The Dow Chemical Company, and TCI America.

The amount of alkanolamine used in the hard surface cleaning compositions of this invention can vary but typically the minimum amount is at least 0.01, more typically at least 0.2 and even more typically 0.5, wt % based on the weight of the cleaning composition. The only limitation on the maximum amount of alkanolamine in the cleaning composition is typically economics and/or diminishing returns on performance, and typically the maximum amount of alkanolamine in the cleaning composition does not exceed 5, more typically does not exceed 2 and even more typically does not exceed 1, wt % based on the weight of the cleaning composition.

### Surfactant

The cleaning composition of this invention contain one or more surfactants selected from nonionic, anionic, cationic, ampholytic, amphoteric and zwitterionic surfactants. A typical listing of anionic, ampholytic, and zwitterionic classes, and species of these surfactants, is given in U.S. Pat. No. 3,929,678. A list of suitable cationic surfactants is given in U.S. Pat. No. 4,259,217. The surfactants are present at a level of from 0.1 to 90, or from 0.1 to 70, or from 0.1 to 50 or from 0.1 to 25, or from 0.1 to 10, or from 0.1 to 8.0, or from 0.1 to 7, or from 0.1 to 6.0, or from 0.1 to 5.0, or from 0.1 to 4.0, or from 0.1 to 3.0 or from 0.1 to 2.0 or from 0.1 to 1.0, percent.

The cleaning composition may comprise an anionic surfactant. Essentially any anionic surfactants useful for detersive purposes can be used in the cleaning composition. These can include salts (including, for example, sodium, potassium, ammonium, and substituted ammonium salts such as mono-, di- and tri-ethanolamine salts) of the anionic sulfate, sulfonate, carboxylate and sarcosinate surfactants. Anionic surfactants may comprise a sulfonate or a sulfate surfactant. Anionic surfactants may comprise an alkyl sulfate, a linear or branched alkyl benzene sulfonate, or an alkyldiphenyloxide disulfonate, as described herein.

Other anionic surfactants include the isethionates such as the acyl isethionates, N-acyl taurates, fatty acid amides of methyl tauride, alkyl succinates and sulfosuccinates, monoesters of sulfosuccinate (for instance, saturated and unsaturated C₁₂-C₁₈ monoesters) diesters of sulfosuccinate (for instance saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C₅-C₁₇acyl-N—(C₁-C₄ alkyl) and —N—(C₁-C₂ hydroxyalkyl) glucamine sulfates, and sulfates of alkylpolysaccharides such as the sulfates of alkylpolyglucoside (the nonionic nonsulfated compounds being described herein). Alkyl sulfate surfactants may be selected from the linear and branched primary C₁₀-C₁₈ alkyl sulfates, the C₁₁-C₁₅ branched chain alkyl sulfates, or the C₁₂-C₁₄ linear chain alkyl sulfates.

Alkyl ethoxysulfate surfactants may be selected from the group consisting of the C₁₀-C₁₈ alkyl sulfates, which have been ethoxylated with from 0.5 to 20 moles of ethylene oxide per molecule. The alkyl ethoxysulfate surfactant may be a C₁₁-C₁₈, or a C₁₁-C₁₅ alkyl sulfate which has been ethoxylated with from 0.5 to 7, or from 1 to 5, moles of ethylene oxide per molecule. One aspect of the invention employs mixtures of the alkyl sulfate and/or sulfonate and alkyl ethoxysulfate surfactants. Such mixtures have been disclosed in WO 93/18124.

Anionic sulfonate surfactants suitable for use in the cleaning compositions of this invention include the salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof Suitable anionic carboxylate surfactants include the alkyl ethoxy carboxylates, the alkyl polyethoxy polycarboxylate surfactants and the soaps (‘alkyl carboxyls’), especially certain secondary soaps as described herein. Suitable alkyl ethoxy carboxylates include those with the formula RO(CH₂CH₂O)ₓCH₂COO⁻ M⁺ wherein R is a C₆ to C₁₈ alkyl group, x ranges from 0 to 10, and the ethoxylate distribution is such that, on a weight basis, the amount of material where x is 0 is less than 20% and M is a cation. Suitable alkyl polyethoxypolycarboxylate surfactants include those having the formula RO--(CHR¹CHR²—O)--R³ wherein R is a C₆ to C₁₈ alkyl group, x is from 1 to 25, R¹ and R² are selected from the group consisting of hydrogen, methyl acid radical, succinic acid radical, hydroxysuccinic acid radical, and mixtures thereof, and R³ is selected from the group consisting of hydrogen, substituted or unsubstituted hydrocarbon having between 1 and 8 carbon atoms, and mixtures thereof

Suitable soap surfactants include the secondary soap surfactants, which contain a carboxyl unit connected to a secondary carbon. Suitable secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressors.

Other suitable anionic surfactants are the alkali metal sarcosinates of formula R--CON(R¹)CH—)COOM, wherein R is a C₅-C₁₇ linear or branched alkyl or alkenyl group, R¹ is a C₁-C₄ alkyl group and M is an alkali metal ion. Examples are the myristyl and oleoyl methyl sarcosinates in the form of their sodium salts.

Other suitable surfactants include fatty acid sarcosinates which are mild, biodegradable anionic surfactants derived from fatty acids and sarcosine (amino acid). Sarcosine is the N-methyl derivative of glycine. Sarcosine is a natural amino acid found in muscles and other tissues. Sarcosine is found naturally as an intermediate in the metabolism of choline to glycine. In a preferred embodiment, the sarcosines are acyl sarcosines. Examples of acyl sarcosines include, but are not limited to, cocoyl sarcosine, lauroyl sarcosine, myristoyl sarcosine, oleoyl sarcosine, stearoyl sarcosine which are modified fatty acids. The salts of acyl sarcosines are referred to acyl sarcosinates. Acyl sarcosinates useful herein include, for example, those having a formula: RCON(CH₃)CH₂COOX wherein R is an alkyl or alkenyl having from 8 to 22 carbon atoms, preferably from 12 to 18 carbon atoms, more preferably from 12 to 14 carbon atoms; and X is a sodium, potassium, ammonium, or triethanolamine.

Examples of acyl sarcosinates that can be used with the present invention include, but not limited to, sodium coccyl sarcosinate, sodium lauroyl sarcosinate and sodium myristoyl sarcosinate, sodium oleoyl sarcosinate, sodium stearoyl sarcosinate, ammonium coccyl sarcosinate, ammonium lauroyl sarcosinate and ammonium myristoyl sarcosinate, ammonium oleoyl sarcosinate and ammonium stearoyl sarcosinate. Commercially available preferred acyl sarcosinates include, but are not limited to, for example, sodium lauroyl sarcosinate having the tradename Hamposyl® L30 which is available from Hampshire Chemicals, and sodium cocoyl sarcosinate having the tradename Hamposyl® C30 which is also available from Hampshire Chemicals.

Other suitable surfactants include fatty alcohol sulfate which has a higher alcohol or alkyl group is normally in the range of 10 to 18 carbon atoms. The cation will almost invariably be sodium or will include sodium, although other cations, such as triethanolamine, potassium, ammonium, magnesium and calcium. Preferred fatty alcohol sulfates are those wherein the fatty alcohol is essentially saturated and is of carbon content(s) within the 10 to 18 carbon atoms range, preferably 10 or 12 to 14 or 16 carbon atoms, such as 12 to 16, or that is derived from coconut oil (coco), palm oil, or palm kernel oil. Lauryl sulfates, and particularly, sodium lauryl sulfate, are preferred primary detergents but such designation also may apply to such detergents wherein the carbon chain length of the alcohol is not limited to 12 carbon atoms, but is primarily (over 50% and normally over 70 or 75%) of 12 to 14 carbon atoms.

Suitable amphoteric surfactants for use herein include the amine oxide surfactants and the alkyl amphocarboxylic acids. Suitable amine oxides include those compounds having the formula R₃(OR₄)ₓNO(R₅)₂ wherein R₃ is selected from an alkyl, hydroxyalkyl, acylamidopropyl and alkylphenyl group, or mixtures thereof, containing from 8 to 26 carbon atoms; R₄ is an alkylene or hydroxyalkylene group containing from 2 to 3 carbon atoms, or mixtures thereof, x is from 0 to 5, preferably from 0 to 3; and each R₅ is an alkyl or hydroxyalkyl group containing from 1 to 3, or a polyethylene oxide group containing from 1 to 3 ethylene oxide groups. Suitable amine oxides are C₁₀-C₁₈ alkyl dimethylamine oxide, and C₁₀₋₁₈ acylamido alkyl dimethylamine oxide. One suitable example of an alkyl amphodicarboxylic acid is Miranol™ C2M Conc. manufactured by Miranol, Inc., Dayton, N.J.

Zwitterionic surfactants can also be incorporated into the cleaning compositions. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwittenionic surfactants.

Suitable betaines are those compounds having the formula R(R₁)₂N⁺R²COO⁻ wherein R is a C₆-C₁₈ hydrocarbyl group, each R¹ is typically C₁-C₃ alkyl, and R² is a C₁-C₅ hydrocarbyl group. Suitable betaines are C₁₂₋₁₈ dimethyl-ammonio hexanoate and the C₁₀₋₁₈ acylamidopropane (or ethane) dimethyl (or diethyl) betaines. Complex betaine surfactants are also suitable for use herein.

Suitable cationic surfactants to be used herein include the quaternary ammonium surfactants. The quaternary ammonium surfactant may be a mono C₆-C₁₆, or a C₆-C₁₀ N-alkyl or alkenyl ammonium surfactant wherein the remaining N positions are substituted by methyl, hydroxyethyl or hydroxypropyl groups. Suitable are also the mono-alkoxylated and bis-alkoxylated amine surfactants. Additional suitable cationic surfactants include coco fatty acid diethanolamine, hydrogenated palm tea ester quat, and cationic ethoxylate fatty acids.

Another suitable group of cationic surfactants, which can be used in the cleaning compositions, are cationic ester surfactants. The cationic ester surfactant is a compound having surfactant properties comprising at least one ester (i.e. —COO—) linkage and at least one cationically charged group. Suitable cationic ester surfactants, including choline ester surfactants, have for example been disclosed in U.S. Pat. No. 4,228,042, 4,239,660 and 4,260,529. The ester linkage and cationically charged group may be separated from each other in the surfactant molecule by a spacer group consisting of a chain comprising at least three atoms (i.e. of three atoms chain length), or from three to eight atoms, or from three to five atoms, or three atoms. The atoms forming the spacer group chain are selected from the group consisting of carbon, nitrogen and oxygen atoms and any mixtures thereof, with the proviso that any nitrogen or oxygen atom in said chain connects only with carbon atoms in the chain. Thus spacer groups having, for example, —O—O— (i.e. peroxide), —N—N—, and —N—O— linkages are excluded, while spacer groups having, for example —CH₂—O—, CH₂-- and —CH₂—NH—CH₂-- linkages are included. The spacer group chain may comprise only carbon atoms, or the chain is a hydrocarbyl chain.

The cleaning composition may comprise cationic mono-alkoxylated amine surfactants, for instance, of the general formula: R¹R²R³N⁺ApR⁴X⁻ wherein R¹ is an alkyl or alkenyl moiety containing from about 6 to about 18 carbon atoms, or from 6 to about 16 carbon atoms, or from about 6 to about 14 carbon atoms; R² and R³ are each independently alkyl groups containing from one to about three carbon atoms, for instance, methyl, for instance, both R² and R³ are methyl groups; R⁴ is selected from hydrogen, methyl and ethyl; X⁻ is an anion such as chloride, bromide, methylsulfate, sulfate, or the like, to provide electrical neutrality; A is a alkoxy group, especially an ethoxy, propoxy or butoxy group; and p is from 0 to 30, or from 2 to 15, or from 2 to 8. The ApR⁴ group in the formula may have p=1 and is a hydroxyalkyl group, having no greater than 6 carbon atoms in which the —OH group is separated from the quaternary ammonium nitrogen atom by no more than 3 carbon atoms. Suitable ApR⁴ groups are —CH₂CH₂—OH, —CH₂CH₂CH₂—OH, -CH₂CH(CH₃)—OH and —CH(CH₃)CH₂—OH. Suitable R¹ groups are linear alkyl groups, for instance, linear R¹ groups having from 8 to 14 carbon atoms.

Suitable cationic mono-alkoxylated amine surfactants for use herein are of the formula R¹(CH₃)(CH₃)N³⁰(CH₂CH₂O)₂₋₅HX⁻ wherein R¹ is C₁₀-C₁₈ hydrocarbyl and mixtures thereof, especially C₁₀-C₁₄ alkyl, or C₁₀ and C₁₂ alkyl, and X is any convenient anion to provide charge balance, for instance, chloride or bromide.

As noted, compounds of the foregoing type include those wherein the ethoxy (CH₂CH₂O) units (EO) are replaced by butoxy, isopropoxy [CH(CH₃)CH₂O] and [CH₂CH(CH₃)O] units (i-Pr) or n-propoxy units (Pr), or mixtures of EO and/or Pr and/or i-Pr units.

The cationic bis-alkoxylated amine surfactant may have the general formula: R¹R²N⁺ApR³A′qR⁴X⁻ wherein R¹ is an alkyl or alkenyl moiety containing from about 8 to about 18 carbon atoms, or from 10 to about 16 carbon atoms, or from about 10 to about 14 carbon atoms; R² is an alkyl group containing from one to three carbon atoms, for instance, methyl; R³ and R⁴ can vary independently and are selected from hydrogen, methyl and ethyl, X⁻ is an anion such as chloride, bromide, methylsulfate, sulfate, or the like, sufficient to provide electrical neutrality. A and A′ can vary independently and are each selected from C₁-C₄ alkoxy, for instance, ethoxy, (i.e., —CH₂CH₂O—), propoxy, butoxy and mixtures thereof, p is from 1 to about 30, or from 1 to about 4 and q is from 1 to about 30, or from 1 to about 4, or both p and q are 1.

Suitable cationic bis-alkoxylated amine surfactants for use herein are of the formula R¹CH₃N⁺(CH₂CH₂OH)(CH₂CH₂OH) X⁻, wherein R¹ is C ₁₀-C₁₈ hydrocarbyl and mixtures thereof, or C₁₀, C₁₂, C₁₄ alkyl and mixtures thereof, X⁻ is any convenient anion to provide charge balance, for example, chloride. With reference to the general cationic bis-alkoxylated amine structure noted above, since in one example compound R¹ is derived from (coconut) C₁₂-C₁₄ alkyl fraction fatty acids, R² is methyl and ApR³ and A′qR⁴ are each monoethoxy.

Other cationic bis-alkoxylated amine surfactants useful herein include compounds of the formula: R¹R²N⁺—(CH₂CH₂O)ₚH—(CH₂CH₂O)_{q}HX⁻ wherein R¹ is C₁₀-C₁₈ hydrocarbyl, or C₁₀-C₁₄ alkyl, independently p is 1 to about 3 and q is 1 to 3, R² is C₁-C₃ alkyl, for example, methyl, and X⁻ is an anion, for example, chloride or bromide.

Other compounds of the foregoing type include those wherein the ethoxy (CH₂CH₂O) units (EU) are replaced by butoxy (Bu) isopropoxy [CH(CH₃)CH₂O] and [CH₂CH(CH₃)O] units (i-Pr) or n-propoxy units (Pr), or mixtures of EU and/or Pr and/or i-Pr units.

The cleaning compositions of this invention may include at least one fluorosurfactant selected from nonionic fluorosurfactants, cationic fluorosurfactants, and mixtures thereof which are soluble or dispersible in the aqueous compositions being taught herein, sometimes compositions which do not include further detersive surfactants, or further organic solvents, or both. Suitable nonionic fluorosurfactant compounds are found among the materials presently commercially marketed under the tradename Fluorad® (ex. 3M Corp.) Exemplary fluorosurfactants include those sold as Fluorad®. FC-740, generally described to be fluorinated alkyl esters; Fluorad® FC-430, generally described to be fluorinated alkyl esters; Fluorad® FC-431, generally described to be fluorinated alkyl esters; and, Fluorad® FC-170-C, which is generally described as being fluorinated alkyl polyoxyethylene ethanols.

An example of a suitable cationic fluorosurfactant compound has the following structure: CₙF₂ₙ⁺¹SO₂NHC₃H₆N⁺(CH₃)₃I⁻ where n.about.8. This cationic fluorosurfactant is available under the tradename Fluorad® FC-135 from 3M. Another example of a suitable cationic fluorosurfactant is F₃—(CF₂)ₙ—(CH₂)ₘSCH₂CHOH—CH₂—N⁺R₁R₂R₃ Cl⁻ wherein: n is 5-9 and m is 2, and R₁, R₂ and R₃ are —CH₃. This cationic fluorosurfactant is available under the tradename ZONYL® FSD (available from DuPont, described as 2-hydroxy-3-((gamma-omega-perfluoro-C₆₋₂₀-alkyl)thio)-N,N,N-trimethy-1-1-propyl ammonium chloride). Other cationic fluorosurfactants suitable for use in the present invention are also described in EP 866,115 to Leach and Niwata. The fluorosurfactant selected from the group of nonionic fluorosurfactant, cationic fluorosurfactant, and mixtures thereof may be present in amounts of from 0.001 to 5 wt %, preferably from 0.01 to 1 wt %, and more preferably from 0.01 to 0.5 wt %.

The cleaning composition may comprise a nonionic surfactant. Essentially any alkoxylated nonionic surfactants are suitable herein, for instance, ethoxylated and propoxylated nonionic surfactants. Alkoxylated surfactants can be selected from the classes of the nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

The condensation products of aliphatic alcohols with from 1 to 25 moles of alkylene oxide, particularly ethylene oxide and/or propylene oxide, are suitable for use herein. The alkyl chain of the aliphatic alcohol can either be straight or branched, primary or secondary, and generally contains from 6 to 22 carbon atoms. Also suitable are the condensation products of alcohols having an alkyl group containing from 8 to 20 carbon atoms with from 2 to 10 moles of ethylene oxide per mole of alcohol.

Polyhydroxy fatty acid amides suitable for use herein are those having the structural formula R²CONR¹Z wherein: R¹ is H, C₁-C₄ hydrocarbyl, 2-hydroxyethyl, 2-hydroxypropyl, ethoxy, propoxy, or a mixture thereof, for instance, C₁-C₄ alkyl, or C₁ or C₂ alkyl; and R² is a C₅-C₃₁ hydrocarbyl, for instance, straight-chain C₅-C₁₉ alkyl or alkenyl, or straight-chain C₉-C₁₇ alkyl or alkenyl, or straight-chain C₁₁-C₁₇ alkyl or alkenyl, or mixture thereof, and Z is a polyhydroxyhydrocarbyl having a linear hydrocarbyl chain with at least 3 hydroxyls directly connected to the chain, or an alkoxylated derivative (for example, ethoxylated or propoxylated) thereof. Z may be derived from a reducing sugar in a reductive amination reaction, for example, Z is a glycityl.

Suitable fatty acid amide surfactants include those having the formula: R¹CON(R²)₂ wherein R¹ is an alkyl group containing from 7 to 21, or from 9 to 17 carbon atoms and each R² is selected from the group consisting of hydrogen, C₁-C₄ alkyl, C₁-C₄ hydroxyalkyl, and —(C₂H₄O)ₓH, where x is in the range of from 1 to 3.

### Solvents

Any water miscible solvent, such as ethylene oxide based or propylene oxide based glycol ethers, may be used in the practice of this invention. The cleaning compositions can contain limited amounts of organic solvents, such as ethanol, sorbitol, glycerol, propylene glycol, and 1,3-propanediol, for example less than 10%, or less than 5%. Sugar alcohols can be suitable for the present invention. Sugar alcohols, include but are not limited to, sorbitol, xilytol, lactitol, maltitol, mannitol, isomalt, erythritol, and mixtures thereof. Monohydric alcohols also can be suitable for the present invention. Monohydric alcohols include, but are not limited to, ethanol, methanol, isopropanol, n-propanol and butanol, t-butanol and mixtures thereof. Polyols are also suitable with the present invention. Polyols include but are not limited to, 1,3-propanediol, 1,3-propanetriol, and propylene glycol and mixtures thereof. Fatty acid methyl ester can be suitable for the present invention. Fatty acid methyl ester, include but are not limited to, alkylated methyl esters (typically of at least 18 carbon atoms), soy-derived fatty acid methyl ester, and canola-derived fatty acid methyl ester. Short chain alcohols, e.g., propanol and glycerol, are also suitable with the present invention. Aloe leaf extract and d-limonine are also suitable solvents for the present invention. Additionally, natural derived triglycerides and lactate ester sorbitol are suitable solvents for the present invention. The present invention can contain solvents such as C₁₋₆ alkanols, other C₁₋₆ diols, C₁₋₁₀ alkyl ethers of alkylene glycols, C₃₋₂₄ alkylene glycol ethers, polyalkylene glycols, short chain esters, isoparafinic hydrocarbons, mineral spirits, alkylaromatics, terpenes, terpene derivatives, terpenoids, terpenoid derivatives, formaldehyde, and pyrrolidones.

Solvents which meet the LVP exemption rule, i.e., those having a vapor pressure lower than 0.1 mm at 20° C. and are Design for the Enviroment (DfE) compliant, are preferred. Glycol ether solvents which are already on the DfE list are: DOWANOL PnB (VOC) (propyleneglycol n-butyl ether CAS 5131-66-8), DOWANOL PnP (VOC) (propyleneglycol n-propyl ether CAS 1569-01-3), DOWANOL DPM (VOC) (Dipropylenenglycol methyl ether CAS 34590-94-8), DOWANOL DPnP (dipropylenegylycol propyl ether CAS 29911-27-1), DOWANOL DPnB (dipropylenegylycol n-butyl ether CAS 35884-42-5), DOWANOL TPnB (tripropyleneglycol n-butyl ether CAS 55934-93-5), DOWANOL TPM (tripropyleneglycol methyl ether, CAS 24598-49-1).

Suitably, the solvent is present in the cleaning composition in an amount ranging from 0.1 to 10 weight percent, or 0.1 to 5.0 weight percent, or 0.1 to 4.0 weight percent, or 0.1 to 3.0 weight percent, or 0.1 to 2.0 weight percent, or 0.1 to 1.0 weight percent, or 0.5 to 5.0 weight percent, or 0.5 to 4.0 weight percent, or 0.5 to 3.0 weight percent, or 0.5 to 2.0 weight percent, or 0.5 to 1.0 weight percent.

### Water

The hard surface cleaning compositions of this invention are aqueous compositions, and water is the dominant component, e.g., water typically comprises at least 50, more typically at least 80 and even more typically at least 90, weight percent of the composition. The water is typically present at a level of less than 99.5%, more typically less than 99% and even more typically less than 98%. Deionized water is preferred. If the cleaning composition is concentrated, then the water may be present in the composition at a concentration of less than 85 wt. %.

### Optional Ingedients

In addition to alkanolamines, surfactants, solvents and water, the cleaning compositions of this invention can include one or more of various optional ingredients known to those skilled in the art. These optional ingredients include, but are not limited to, alkaline agents, builders, fragrances, preservatives, biocides, colorants, dyes and rheology modifiers. These optional ingredients are used in known quantities and in known ways.

Suitable alkaline agents include, but are not limited to, alkali metal hydroxides and alkanolamines (other than those identified as component (C) in the inventive cleaing compositions described above), including monoethanolamine, diethanolamine, monoisopropanolamine, diisopropanolamine and triisopropanolamine. If present, then the alkaline agent is typically present in an amount from 0.1 to 5 wt % of the cleaning composition.

If present at all, the cleaning compositions of this invention contain at least, preferably more, than 0.2 wt % builder. Suitably, the builder is present in the cleaning composition in an amount ranging from 0.2 to 5 weight percent, or 0.2 to less than 4 weight percent, or 0.2 to 0.3 weight percent, or 0.2 to 2 weight percent, or 0.2 to 1 weight percent.

The builder can also function as a softener, a sequestering agent, a buffering agent, or a pH adjusting agent in the cleaning composition. A variety of builders or buffers can be used and they include, but are not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxy-sulfonates, and starch derivatives. Builders, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2-methylpropanol.

Preferred buffering agents for compositions of this invention are nitrogen-containing materials. Some examples are amino acids such as lysine or lower alcohol amines like mono-, di-, and tri-ethanolamine. Other preferred nitrogen-containing buffering agents are disodium glutamate, N-methyl diethanolamide, 1,3-bis(methylamine)-cyclohexane, 1,3-diamino-propanol-N,N′-tetra-methyl-1,3-diamino-2-propanol, N,N-bis(2-hydroxyethyl)-glycine (bicine) and N-tris(hydroxy-methyl)methyl glycine (tricine). Other suitable buffers include ammonium carbamate, citric acid, and acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. Additional buffers are described in WO 95/07971. Other preferred pH adjusting agents include sodium or potassium hydroxide. The term silicate is meant to encompass silicate, metasilicate, polysilicate, aluminosilicate and similar compounds.

The cleaning compositions optionally contain dyes, colorants and preservatives, or contain one or more, or none of these components. These dyes, colorants and preservatives can be natural or synthetic. Natural preservatives include benzyl alcohol, potassium sorbate and bisabalol; sodium benzoate and 2-phenoxyethanol. Preservatives, when used, include, but are not limited to, mildewstat or bacteriostat, methyl, ethyl and propyl parabens, short chain organic acids (e.g. acetic, lactic and/or glycolic acids), bisguanidine compounds (e.g. Dantagard and/or Glydant) and/or short chain alcohols (e.g. ethanol and/or IPA). The mildewstat or bacteriostat includes, but is not limited to, mildewstats (including non-isothiazolone compounds) including KATHON GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from The Dow Chemical Company; BRONOPOL, a 2-bromo-2-nitropropane 1,3 diol, from Boots Company Ltd. and The Dow Chemical Company, PROXEL CRL, a propyl-p-hydroxybenzoate, from ICI PLC; NIPASOL M, an o-phenyl-phenol, Na⁺ salt, from Nipa Laboratories Ltd., DOWICIDE A, a 1,2-Benzoisothiazolin-3-one, from The Dow Chemical Company, and IRGASAN DP 200, a 2,4,4′-trichloro-2-hydroxydiphenylether, from Ciba-Geigy A.G. Dyes and colorants include synthetic dyes such as LIQUITINT®. Yellow or Blue or natural plant dyes or pigments, such as a natural yellow, orange, red, and/or brown pigment, such as carotenoids, including, for example, beta-carotene and lycopene.

pH

The pH of the cleaning composition is measured directly without dilution. The cleaning compositions can have a pH of 7 or above, or 7.5 or above, or 8 or above, or 9 or above, or 10 or above, or from 7.5 to 11, or from 8 to 11, or from 9 to 11.

### Preparation of the Cleaning Composition

The cleaning compositions of this invention can be prepared using known methods and equipment. The ingredients of the compostion can be added in any order, and are usually added to water under ambient conditions with good mixing to create a homogeneous mixture, typically a solution. The cleaning compositions can be prepared either as a concentrate formulation (typically for shipping and/or storage purposes) or as a ready-to-use formulation.

### Use of the Cleaning Composition

The cleaning compositions of this invention are used in known ways with known equipment. Concentrates are typically diluted with water and/or solvent prior to use. The cleaning compositions can be applied directly to the surface to be cleaned or to a cleaning tool, e.g., cloth, wipe, microfiber, sponge, etc., which is then applied to the surface.

The invention is further described by the following examples.

### SPECIFIC EMBODIMENTS

Preparation of Samples Comparing Inventive Alkanolamines with DIPA and TIPA

Twenty, 15 gram (g) samples were prepared. Each sample contained one or more of three surfactants available from The Dow Chemical Company, i.e., TRITON CG-50 (a nonionic, alkyl polyglucoside), and ECOSURF EH-6 and ECOSURF EH-9 (both nonionic, alcohol ethoxylates).

Each sample also contained one or more of six solvents available from The Dow Chemical Company, i.e., DOWANOL PnB (propylene glycol n-butyl ether), DOWANOL DPM (dipropylene glycol methyl ether), Butyl CARBITOL™ Solvent (BuCb, diethylene glycol monobutyl ether), DOWANOL DPnB (dipropylene glycol n-butyl ether), DOWANOL TPnB (tripropylene glycol n-butyl ether) and DOWANOL TPM (tripropylene glycol methyl ether).

In addition each of the samples contained one of tris(hydroxymethyl)amino methane (TRISAMINO); 2-amino-2-methyl-1,3-propanediol (AMPD); 2-amino-2-ethyl-1,3-propanediol (AEPD VOX 1000); 2-amino-2-methyl-1-propanol (AMP-95); 3-amino-4-octanol (CORRGUARD EXT), dimethylamino-2-methyl-1-propanol (DMAMP 80), diisopropanol amine (DIPA) and TIPA (triisopropanol amine). Most of the samples also contained sodium hydroxide. The actives made up about 4% of the sample by weight with the balance being deionized water.

Each sample was evaluated visually at 5° C., 20° C., and 50° C. to determine homogeneity. The filming and streaking performance of each sample was quantified according to the procedure described below. Cleaning performance as measured by Gray Value was determined according to the procedure described below.

Preparation of Samples Comparing Inventive Alkanolamines with MEA for Stability

Ninety six samples were made up using an automated liquid handler to dispense the various ingredients into 1 milliliter (ml) sample tubes for the monoethanolamine (MEA) and each of the six inventive alkanolamines according to the Matrix Chart below. The 672 samples contained on six full 96-well sample trays were evaluated for phase stability visually.

Matrix Chart
Preparation of Phase Stability Samples* with MEA and Inventive Alkanolamines

| | Dowanol DPnP | | | Dowanol DPnB | | | Dowanol TPM | | | Butyl Carbitol | | |
|---|---|---|---|---|---|---|---|---|---|---|---|---|
| | 1 | 2 | 3 | 1/ | 2 | 3 | 1/ | 2 | 3 | 1 | 2 | 3 |
| 0.5 w/w/% | w/w % | w/w % | w/w % | w/w % | w/w/% | w/w % | w/w % | w/w % | w/w % | w/w % | w/w % | w/w % |
| Surfactant | 1 | 2 | 3 | 4 | 5 | 6 | 7 | 8 | 9 | 10 | 11 | 12 |

| | |
|---|---|
| Triton CG-50 | A |
| APG 12-14 | B |
| (0.05%) | |
| Dowfax 2A1 | C |
| Dowfax C10L | D |
| Ecosurf SA-9 | E |
| Ecosurf EH-6 | G |
| Ecosurf EH-9 | H |

*Each sample contained 0.5 w/w % Amine, 0.2% NaOH, and 0.5% Dowanol PnB in each formulation.

Samples A and B are comparative compositions comprising nonionic polyalkyl glucoside surfactants. Samples C and D are inventive compositions comprising anionic surfactants and Samples E-H are inventive compositions comprising nonionic surfacants.
Preparation of Samples with Inventive Alkanolamines and MEA for Performance Testing

Fifteen to twenty stable formulations for each amine were chosen from the Matrix Chart above to give as broad a coverage of the variables as possible. These formulations were prepared in 15 mL quantities for filming and streaking and cleaning performance testing.

One hundred twenty-three (123) homogeneous samples were chosen for filming and streaking evaluation and for cleaning evaluation according to the procedures described below.

### Filming and Streaking Test Procedure

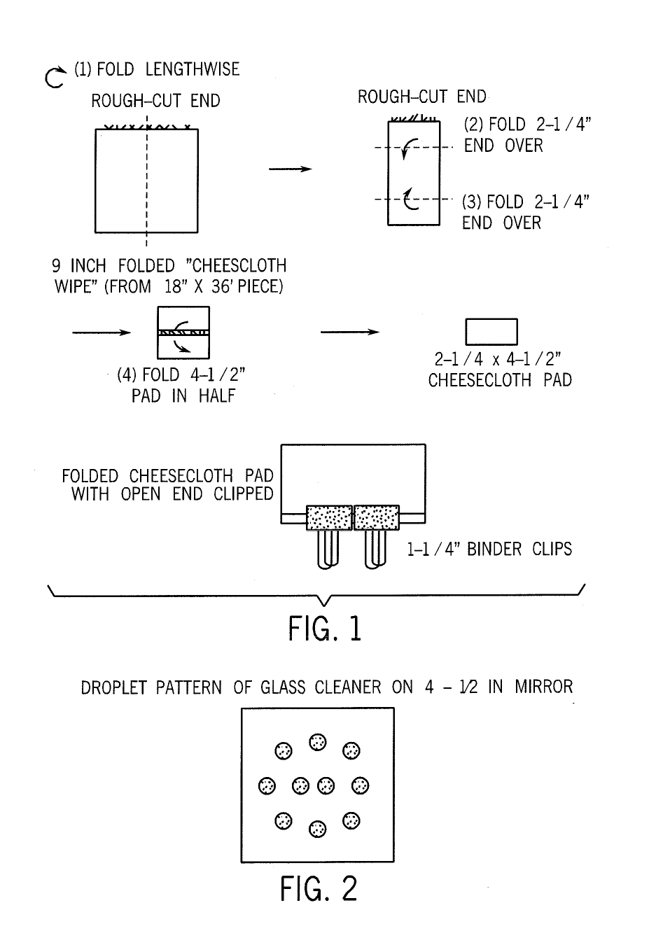

Fold a 9 inch square of cheesecloth as described in FIG. 1 to an approximately 4.5×2.25 inch rectangle and attach binder clips to act as handles. On a clean mirror tile place ten drops of test solution into a pattern of eight drops forming a circle and two drops in the center of the circle (as illustrated in FIG. 2). Immediately stroke the surface ten times with the folded cheesecloth applying no downward pressure. Each movement back or forth counts as a pass. Repeat the procedure for all solutions, two tiles per solution for duplicates and standards of WINDEX® and FANTASTIK® hard surface cleaning compositions. Allow the tiles to dry completely for at least 20 minutes. Observe and rank the tiles according to Filming and Streaking on a scale of 1-10.
Filming: 1=no visible filming (compare to WINDEX), and 10=high filming/haziness (compare to FANTASTIK).
Streaking: 1=no visible streaking (compare to WINDEX and FANTASTIK), and 10=high streaking.
   All tiles were rated by the same operator to minimize discrepancies in rating and to eliminate differences due to a change in operators.

### Hard Surface Cleaning: Spring Compression Device (SCiD)

The hard surface cleaning power of the formulations was tested by the removal of soil from a vinyl tile. Vinyl tiles were cut to match the sample size of 11.5 cm×7.5 cm and 500 μL of 3% Carbon Black Brazil soil was applied to the grooved side of the tile using a foam applicator and set to dry for approximately 24 hours. The tile was placed in the SCiD plate and set on the orbital shaker. Four hundred (400) μL of the cleaning solutions were dispensed into each well along with one carpeted srubbie and were run on the shaker for five minutes. For each sample, 3 wells were tested and the samples were run with a good and medium cleaning standard. The samples were scanned into the computer and analyzed by ImageJ software. The cleaning power was measured by the average gray value of the well and the cleaning power of the sample was measured by the average of the gray value of the three wells. A higher gray value corresponds to a lighter circle and a higher cleaning power while a lower gray value corresponds to a darker circle and a lower cleaning power.

### Brazil Soil Composition

| INGREDIENT | wt % |
|---|---|
| Naphtha 60/110 | 61.06 |
| Edenor EV 85 BR (C8-C10 fatty acid) | 27.62 |
| soybean oil | 8.15 |
| carbon black | 3.17 |

### Stability

Stability at high and low temperatures was tested for the best cleaning formulations. Approximately 5 mL of the cleaning formulation was placed in a small glass vial and capped. Three vials were done per formulation as each was tested in an oven at 50° C., in a refrigerator, and in a freezer for a minimum of three hours. The solutions were brought back to room temperature and given a quick shake. Stability was observed if the formulation had a homogenous appearance and there was no visible layering.

### Results

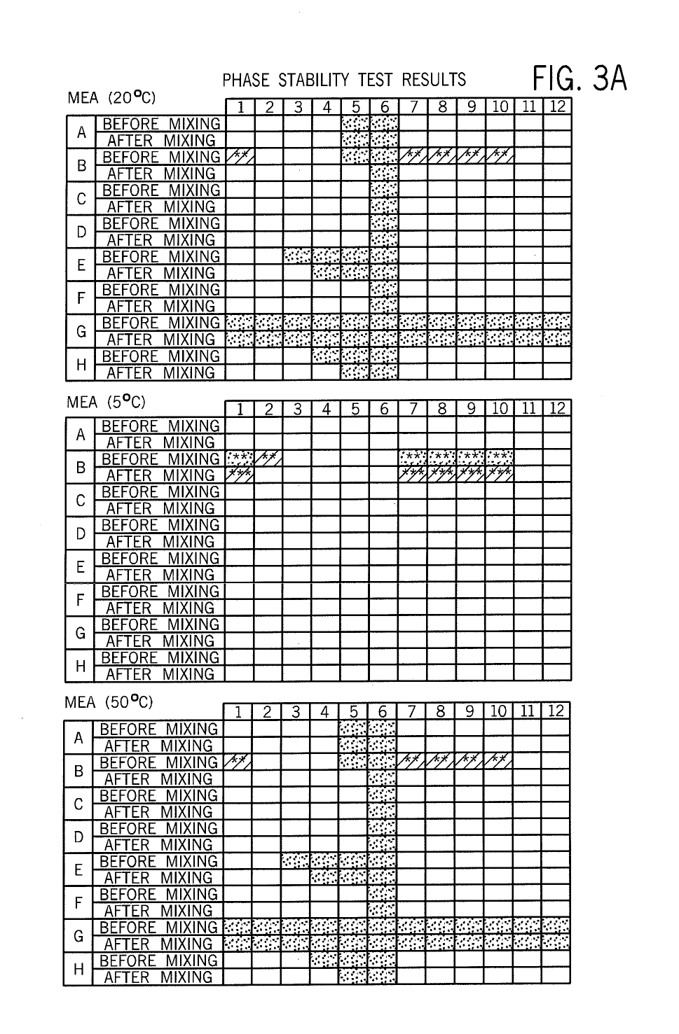

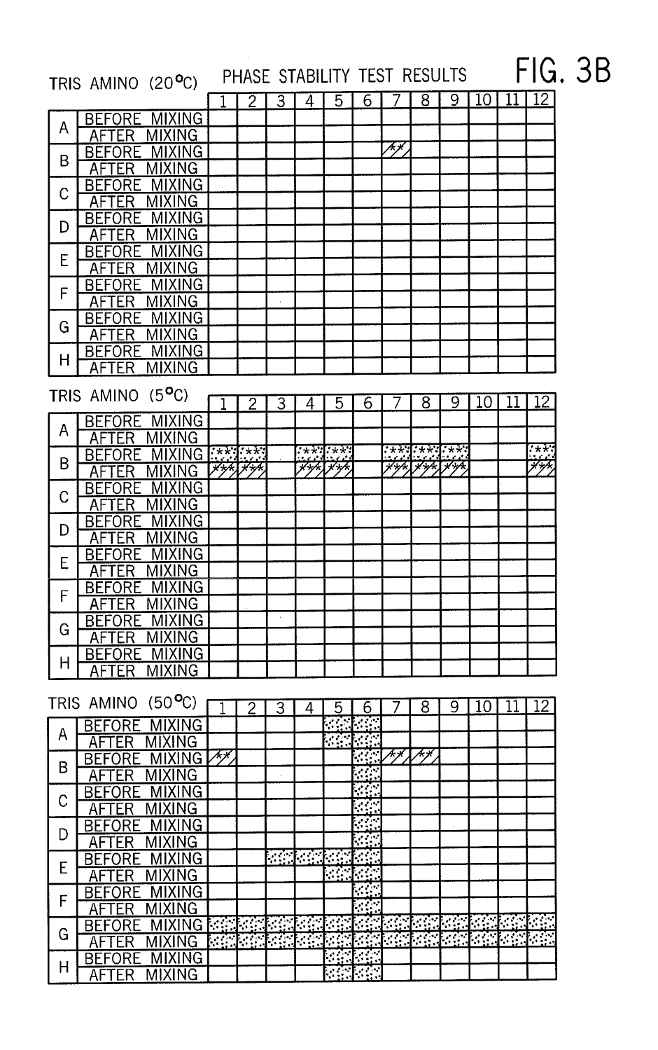

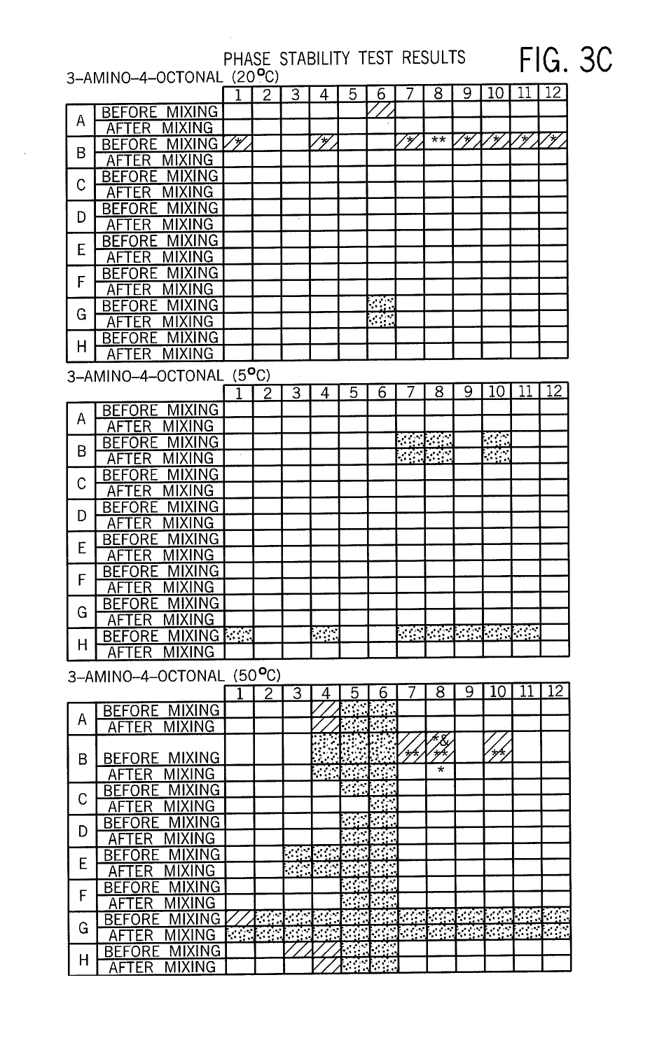

The sample formulations and the results of the stability and cleaning performance testing are reported in Tables 1A-1D. FIGS. 3A-3C are a collection of graphs comparing the stability compositions comprising MEA at 5, 20 and 50° C. with compositions comprising tris(hydroxymethyl)amino methane or 3-amino-4-octanol at the same temperatures. Each sample has a before mixing and after mixing result. Green (medium grey) represents homogeneous, yellow (light grey) a small amount of a second phase, and red (dark grey) clearly two phases. As seen from these graphs, the inventive compositions are as stable as the MEA-containing compositions.

TABLE 1A
Filming, Streaking and Cleaning Performance Results of
the Inventive Alkanolamines vs. DIPA and TIPA (Surfactants)

| | TRITON CG-50 | | ECOSURF EH-6 | | ECOSURF EH-9 | |
|---|---|---|---|---|---|---|
| Sample* | wt % | g | wt % | g | wt % | g |
| 1 | | | 0.50% | 0.075 | 0.50% | 0.075 |
| 2 | 0.50% | 0.075 | 0.50% | 0.075 | 0.50% | 0.075 |
| 3 | | | 0.50% | 0.075 | 0.50% | 0.075 |
| 4 | 0.50% | 0.075 | 0.50% | 0.075 | 0.50% | 0.075 |
| 5 | | | 0.50% | 0.075 | 0.50% | 0.075 |
| 6 | 0.50% | 0.075 | 0.50% | 0.075 | 0.50% | 0.075 |
| 7 | | | 0.50% | 0.075 | 0.50% | 0.075 |
| 8 | 0.50% | 0.075 | 0.50% | 0.075 | 0.50% | 0.075 |
| 9 | | | 0.50% | 0.075 | 0.50% | 0.075 |
| 10 | 0.50% | 0.075 | 0.50% | 0.075 | 0.50% | 0.075 |
| 11 | | | 0.50% | 0.075 | 0.50% | 0.075 |
| 12 | 0.50% | 0.075 | 0.50% | 0.075 | 0.50% | 0.075 |
| 13 | | | 0.50% | 0.075 | 0.50% | 0.075 |
| 14 | 0.50% | 0.075 | 0.50% | 0.075 | 0.50% | 0.075 |
| 15 | | | 0.50% | 0.075 | 0.50% | 0.075 |
| 16 | 0.50% | 0.075 | 0.50% | 0.075 | 0.50% | 0.075 |
| 17 | 0.50% | 0.075 | | | 0.50% | 0.075 |
| 18 | | | | | 1.00% | 0.15 |
| 19 | 0.50% | 0.075 | 1.00% | 0.15 | | |
| 20 | | | 0.50% | 0.075 | 0.50% | 0.075 |

*Samples 1-4 and 17-20 are control or comparative samples. Samples 5-16 are inventive samples.

TABLE 1B
Filming, Streaking and Cleaning Performance Results
of the Inventive Alkanolamines vs. DIPA and TIPA (Alkanolamines)

| | | | | | | | | NaOH | |
|---|---|---|---|---|---|---|---|---|---|
| Sample* | DIPA | (g) | TIPA | (g) | Amines | | (g) | (50%) | (g) |
| 1 | 0.50% | 0.075 | | | | | | 0.20% | 0.03 |
| 2 | 0.50% | 0.075 | | | | | | 0.20% | 0.03 |
| 3 | | | 0.50% | 0.075 | | | | 0.20% | 0.03 |
| 4 | | | 0.50% | 0.075 | | | | 0.20% | 0.03 |
| 5 | | | | | 1 | 0.50% | 0.075 | 0.20% | 0.03 |
| 6 | | | | | 1 | 0.50% | 0.20% | 0.20% | 0.03 |
| 7 | | | | | 2 | 0.50% | 0.20% | 0.20% | 0.03 |
| 8 | | | | | 2 | 0.50% | 0.20% | 0.20% | 0.33 |
| 9 | | | | | 3 | 0.50% | 0.20% | 0.20% | 0.03 |
| 10 | | | | | 3 | 0.50% | 0.20% | 0.20% | 0.03 |
| 11 | | | | | 4 | 0.50% | 0.20% | 0.20% | 0.03 |
| 12 | | | | | 4 | 0.50% | 0.20% | 0.20% | 0.03 |
| 13 | | | | | 5 | 0.50% | 0.20% | 0.20% | 0.03 |
| 14 | | | | | 5 | 0.50% | 0.20% | 0.20% | 0.33 |
| 15 | | | | | 6 | 0.50% | 0.20% | 0.20% | 0.03 |
| 16 | | | | | 6 | 0.50% | 0.20% | 0.20% | 0.03 |
| 17 | 0.50% | 0.075 | | | | | | | |
| 18 | | | 0.50% | 0.075 | | | | 0.20% | 0.03 |
| 19 | | | 0.50% | 0.075 | | | | 0.20% | 0.03 |
| 20 | 0.50% | 0.075 | | | | | | | |

| | |
|---|---|
| Amine #1 | TRIS AMINO 40% concentrate |
| Amine #2 | AMPO CRYSTALS |
| Amine #3 | 3-AMINO-4-ALCOHOL |
| Amine #4 | AEPD VOX 1000 |
| Amine #5 | AMP-95 |
| Amine #6 | DMAMP-80 |

*Samples 1-4 and 17-20 are control or comparative samples. Samples 5-16 are inventive samples.

TABLE 1C
Filming, Streaking and Cleaning Performance Results
of the Inventive Alkanolamines vs. DIPA and TIPA (Solvents)

| Sample* | PnB | (g) | DPM | (g) | BuCb | (g) | DPnB | (g) | TPnB | (g) | TPM | (g) |
|---|---|---|---|---|---|---|---|---|---|---|---|---|
| 1 | 0.50% | 0.075 | | | | | 0.50% | 0.075 | | | 1.00% | 0.15 |
| 2 | | | 0.50% | 0.075 | | | 0.50% | 0.075 | | | 1.00% | 0.15 |
| 3 | 0.50% | 0.075 | | | | | 0.50% | 0.075 | | | 1.00% | 0.15 |
| 4 | | | 0.50% | 0.075 | | | 0.50% | 0.075 | | | 1.00% | 0.15 |
| 5 | 0.50% | 0.075 | | | | | 0.50% | 0.075 | | | 1.00% | 0.15 |
| 6 | | | 0.50% | 0.075 | | | 0.50% | 0.075 | | | 1.00% | 0.15 |
| 7 | 0.50% | 0.075 | | | | | 0.50% | 0.075 | | | 1.00% | 0.15 |
| 8 | | | 0.50% | 0.075 | | | 0.50% | 0.075 | | | 1.00% | 0.15 |
| 9 | 0.50% | 0.075 | | | | | 0.50% | 0.075 | | | 1.00% | 0.15 |
| 10 | | | 0.50% | 0.075 | | | 0.50% | 0.075 | | | 1.00% | 0.15 |
| 11 | 0.50% | 0.075 | | | | | 0.50% | 0.075 | | | 1.00% | 0.15 |
| 12 | | | 0.50% | 0.075 | | | 0.50% | 0.075 | | | 1.00% | 0.15 |
| 13 | 0.50% | 0.075 | | | | | 0.50% | 0.075 | | | 1.00% | 0.15 |
| 14 | | | 0.50% | 0.075 | | | 0.50% | 0.075 | | | 1.00% | 0.15 |
| 15 | 0.50% | 0.075 | | | | | 0.50% | 0.075 | | | 1.00% | 0.15 |
| 16 | | | 0.50% | 0.075 | | | 0.50% | 0.075 | | | 1.00% | 0.15 |
| 17 | 0.50% | 0.075 | | | 1.00% | 0.15 | | | 0.50% | 0.075 | | |
| 18 | | | 0.50% | 0.075 | 1.00% | 0.15 | | | 0.50% | 0.075 | | |
| 19 | 0.50% | 0.075 | | | 1.00% | 0.15 | | | 0.50% | 0.075 | | |
| 20 | | | 0.50% | 0.075 | 1.00% | 0.15 | | | 0.50% | 0.075 | | |

*Samples 1-4 and 17-20 are control or comparative samples. Samples 5-16 are inventive samples.

TABLE 1D
Filming, Streaking and Cleaning Performance Results
of the Inventive Alkanolamines vs. DIPA and TIPA (Test Results)

| | Stability | | | | | |
|---|---|---|---|---|---|---|
| Sample* | RT | 40 c. | Freezer | Filming | Streaking | AVG Grey |
| 1 | Clear | Clear | Clear | 1 | 1 | 106.00 |
| 2 | Clear | Clear | Clear | 2 | 2 | 104.35 |
| 3 | Clear | Clear | Clear | 4 | 4 | 108.06 |
| 4 | Clear | Clear | Clear | 8 | 3 | 94.66 |
| 5 | Clear | Clear | Clear | 8 | 3 | 121.35 |
| 6 | Clear | Clear | Clear | 5 | 3 | 108.09 |
| 7 | Clear | Clear | Clear | 5 | 4 | 111.61 |
| 8 | Clear | Clear | Clear | 3 | 2 | 111.07 |
| 9 | Clear | Clear | Clear | 4 | 3 | 125.49 |
| 10 | Clear | Clear | Clear | 4 | 3 | 110.38 |
| 11 | Clear | Clear | Clear | 3 | 2 | 115.72 |
| 12 | Clear | Clear | Clear | 3 | 1 | 99.05 |
| 13 | Clear | Clear | Clear | 5 | 2 | 100.76 |
| 14 | Clear | Clear | Clear | 4 | 2 | 88.86 |
| 15 | Clear | Clear | Clear | 4 | 2 | 114.85 |
| 16 | Clear | Clear | Clear | 5 | 3 | 95.22 |
| 17 | Clear | Clear | Clear | 2 | 1 | 50.25 |
| 18 | Clear | Clear | Clear | 4 | 2 | 99.46 |
| 19 | Clear | Clear | Clear | 7 | 2 | 111.67 |
| 20 | Clear | Clear | Clear | 5 | 2 | 105.39 |

*Samples 1-4 and 17-20 are control or comparative samples. Samples 5-16 are inventive samples.

Samples 1-4 and 17-20 are comparative compositions. While all the compositions comprise low or zero VOC alkanolamines, only the comparative compositions have a noticeable alkanolamine odor. All of the samples were clear, homogeneous solutions at freezer (˜5° C.), room temperature (RT) (˜20° C.), and elevated temperature (˜50° C.) conditions. Filming and streaking numbers of less than (<) 5 are acceptable, and most of the samples met that criteria. The average gray values were in the range of 85 to 125.

Based on the positive results from the screening experiments, samples of each of the alkanolamines and MEA were prepared with the amine at 0.5 wt % using one of three surfactants at 0.5 wt % and one of six solvents where the solvents were tested at three different levels. Each sample also contained 0.5 wt % PnB, and 0.2 wt % sodium hydroxide. The 672 samples were prepared using an automated liquid handler and then split into three parts for evaluation of phase stability at 5, 20, and 50° C.

Each sample has a before mixing and after mixing result. Many of the samples were homogeneous even before mixing. Some others had a small amount of a second phase before mixing but became homogeneous with mixing. Some of the samples were clearly two phase before mixing but either became homogeneous or nearly homogeneous after mixing. Finally, some of the samples remained heterogeneous even after mixing. This occurred primarily at 50° C.

All six of the inventive alkanolamines gave good performance for cleaning compared to the control MEA. Surprisingly, even though they are zero VOC, AMPD and AEPD actually gave comparable filming and streaking to MEA, and most of the other amines gave acceptable filming and streaking performance.

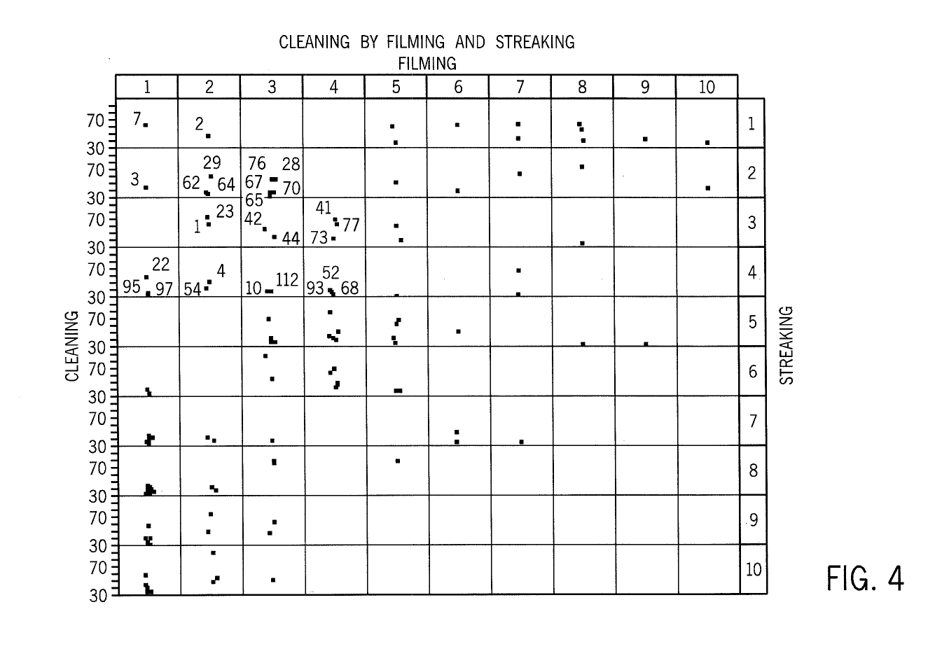

Results from the 123 experiments are plotted in FIG. 4. Filming results are shown on a 1 to 10 scale across the top of the figure. Streaking results are shown on a 1 to 10 scale on the right side of the figure. Since filming and streaking levels of less than or equal to (≦) 4 are generally required, the good samples are those located in the 4×4 square in the upper left hand corner. Cleaning performance is shown on the left side of the figure. Within each row of small squares, cleaning results are plotted on a 30 to 100 scale, so the higher up in the individual box, the better the cleaning performance.

The best formulation, #7, is MEA based, and another MEA based formulation, #1 gave good results, but #22, 23, 29, and 41 containing AMPD gave good cleaning results with acceptable filming and streaking. Likewise, #42 and 44 with tris(hydroxymethyl)amino methane, and #76 and 77 with 3-amino-4-octanol also gave good cleaning with acceptable filming and streaking.

Although the invention has been described with certain detail through the preceding description of the preferred embodiments, this detail is for the primary purpose of illustration. Many variations and modifications can be made by one skilled in the art without departing from the spirit and scope of the invention as described in the following claims.

1. A cleaning solution having a vapor pressure of 0.1 mm Hg or less at 20° C., the solution comprising in weight present based on the weight of the solution:
A. 0.1 to 8 wt % surfactant;
B. 0.1 to 1 wt % of a water-miscible solvent;
C. 0.1 to 5 wt % alkanolamine selected from the group consisting of tris(hydroxymethyl)amino methane; 2-amino-2-methyl-1,3-propanediol; 2-amino-2-ethyl-1,3-propanediol; N,N-dimethylamino-2-methyl-1-propanol; and 3-amino-4-octanol; and
D. at least 80 wt % water.

2. The cleaning solution of claim 1 in which the water is de-ionized and comprises between 90 and 99.5 wt % of the solution.

3. The cleaning solution of claim 1 in which the surfactant is an alkoxylated nonionic surfactant.

4. The cleaning solution of claim 1 in which the surfactant is an alcohol ethoxylate.

5. The cleaning solution of claim 1 in which the solvent is one or more of propyleneglycol n-butyl ether, propyleneglycol n-propyl ether, dipropylenenglycol methyl ether, dipropylenegylycol propyl ether, dipropylenegylycol n-butyl ether, tripropyleneglycol n-butyl ether, and tripropyleneglycol methyl ether.

6. The cleaning solution of claim 1 further comprising at least one of an alkaline agent, builder, fragrance, preservative, biocide, colorant, dye and rheology modifier.

7. The cleaning solution of claim 1 further comprising an alkali metal hydroxide.

8. The cleaning solution of claim 1 in which the alkanolamine is at least one of tris(hydroxymethyl)amino methane and 3-amino-4-octanol.
